(19) United States
(12) Patent Application Publication
(10) Pub. No.: US 2005/0132767 A1
(43) Pub. Date: Jun. 23, 2005

(54) Exterior cam lock

(75) Inventor: Lawrence L. Freck, Crystal Lake, IL (US)

Correspondence Address: VEDDER PRICE KAUFMAN & KAMMHOLZ, 222 N. LASALLE STREET, CHICAGO, IL, 60601, US

(73) Assignee: Royal Lock Corporation a corporation of the State of Illinois

(21) Appl. No.: 11/053,790

(22) Filed: Feb. 9, 2005

Related U.S. Application Data
(63) Continuation-in-part of application No. 10/360,184, filed on Feb. 6, 2003.

(51) Int. Cl. E05B 9/04; E05B 27/00

(52) U.S. Cl. 70/375; 70/491

(57) ABSTRACT

A key-actuated cam lock includes a lock housing having a first end and a second end. The lock housing includes a bore that extends from the first end to the second end to house a plug body. The plug body includes a first end, a second end, and a plurality of spring-biased tumblers that can be engaged with a key to open and close the lock. The first end of the lock housing includes a circumferential inner rim that is sized to house the first end of the plug body. A closure plate that includes a key opening partially covers the first end of the plug body. A generally cylindrical metal cap is attached to the first end of the lock housing to securely cover the first end of the~lock housing, the first end of the plug body and portions of the closure plate. The first end of the lock housing, the closure plate and the metal cap collectively define a lock face. When the lock is attached to an object, the lock face is sized, shaped and arranged so as to be positioned substantially coplanar relative to an outer surface of the object.

### FIELD OF THE INVENTION

This disclosure generally relates to locks, and, more particularly, to a corrosion- and weather-resistant key-actuated cam lock.

### BACKGROUND

Conventional locking systems are typically designed for interior use. The exterior use of such locks can result in lock malfunction when the locking system is exposed to the elements and other harsh environmental conditions. A conventional key-actuated cam lock designed for outside applications can pass fewer than 240 hours of salt spray testing prior to malfunctioning.

Exemplary conventional locks and keys are disclosed in U.S. Pat. No. 4,006,616 to Rubner et al., U.S. Pat. No. 4,425,770, U.S. Pat. No. 4,099,398 to Lipschutz, U.S. Pat. No. 4,715,201 to Craig, U.S. Pat. No. 5,199,285 to Lin, U.S. Pat. No. 5,265,455 to Grinuner, U.S. Pat. No. 5,491,993 to Anderson, and C. T. Johnson Enterprises sales literature. All of these devices have a number of drawbacks. Locks that have weather-resistant features are typically larger than interior locks so as to accommodate the various weather-resistant features incorporated therein. For instance, the front side of such locks, which is the side that is outside an object to which the lock is attached, is typically large and projects outward from the object. The large front side of such locks accommodates some of the weather-resistant features of these locks, such as gaskets, seals, O-rings, etc. Therefore, there is a need for an exterior lock with weather-resistant features that also includes a low-profile front face.

### SUMMARY

In accordance with a principal aspect of the present disclosure, a key-actuated cam lock for attachment to an object includes a plug body having a first end and a second end, said plug body further including a plurality of spring-biased tumblers engaging the key when the key is inserted into said plug body. The cam lock further includes a closure plate configured to partially cover the first end of said plug body, said closure plate having a substantially flat outer face, the outer face having a key opening to permit entry of the key. The cam lock further includes a lock housing having a first end and a second end, said lock housing having a bore extending from the first end to the second end and configured to rotatably house said plug body, the first end having a circumferential inner rim sized and arranged for mating engagement with the first end of the plug body. A portion of the first end of said lock housing having engaged therein at least a portion of said first end of the plug body, and at least a portion of the closure plate define a lock face. Additionally, said lock face is configured to be substantially coplanar relative to an outer surface of the object when said lock housing is attached to the object.

In accordance with another principal aspect of the present disclosure, a key-actuated cam lock includes a plug body having a first end and a second end, said plug body further including a plurality of spring-biased tumblers engaging the key when the key is inserted into said plug body, the first end of said plug body extending outwardly from an outer surface of an object when said plug body is attached to the object to partially define a lock face, wherein the lock face is substantially coplanar with the outer surface of the object when said plug body is attached to the object. The cam lock further includes a weather-resistant closure plate configured to partially cover the first end of said plug body, said closure plate having a substantially flat outer face, the outer face having a key opening to permit entry of the key. The cam lock also includes a corrosion-resistant lock housing having a first end and a second end, said lock housing having a bore extending from the first end to the second end and configured to rotatably house said plug body, the first end having a circumferential inner rim configured and arranged for mating engagement with the first end of the plug body. The cam lock further includes an O-ring disposed between said plug body and said lock housing substantially near the second end of the lock housing, said O-ring configured to provide a weather-resistant seal between said plug body and said lock housing; and, a generally annular corrosion-resistant metal cap having a centrally disposed aperture and a substantially flat top surface, wherein the metal cap is configured for mating engagement over a circumferential outer rim of said lock housing.

In accordance with yet another principal aspect of the present disclosure, a method of creating a weather-resistant exterior cam lock includes plating at least two components of said cam lock with a corrosion-resistant metal, said components selected from the group consisting of a cylindrical metal cap, having a centrally disposed aperture and a substantially flat top surface, a weather-resistant closure plate having an openable trap door permitting the entry of a key, a plug body, said plug body having a first end and a second end, spring-biased disc tumblers, a lock housing, said lock housing having a substantially cylindrical head circumferentially disposed about a first end of said lock housing, said cylindrical head configured for mating engagement with said corrosion-resistant metal cap; said mating of said cylindrical head and said metal cap partially providing a lock face being substantially coplanar relative to an outer surface of an object when said cam lock is attached to said object; a metal stop plate, and a rotatable cam. The method also includes providing a weather-resistant seal substantially near the second end of said plug body, said weather-resistant seal disposed between the second end of said plug body and said lock housing. The method further includes assembling said components of said weather-resistant exterior cam lock.

### BRIEF DESCRIPTION OF THE DRAWINGS

FIG. 1 is a perspective view of a key-actuated cam lock constructed in accordance with the teachings of the present disclosure;

FIG. 2 is a front view of the key-actuated cam lock of FIG. 1;

FIG. 3 is a side view of the key-actuated cam lock of FIG. 1 shown attached to an object;

FIG. 4 is a rear view of the key-actuated cam lock of FIG. 1;

FIG. 5 is a side cross sectional view of a lock housing of the key-actuated cam lock of FIG. 1; and

FIG. 6 is an exploded perspective view of the key-actuated cam lock of FIG. 1.

### DETAILED DESCRIPTION

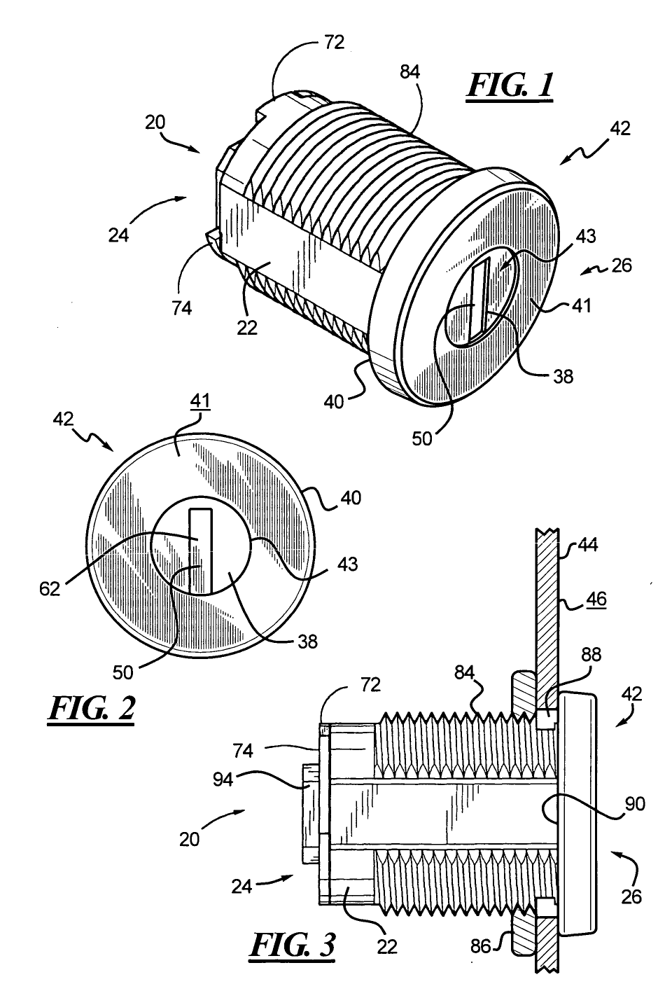

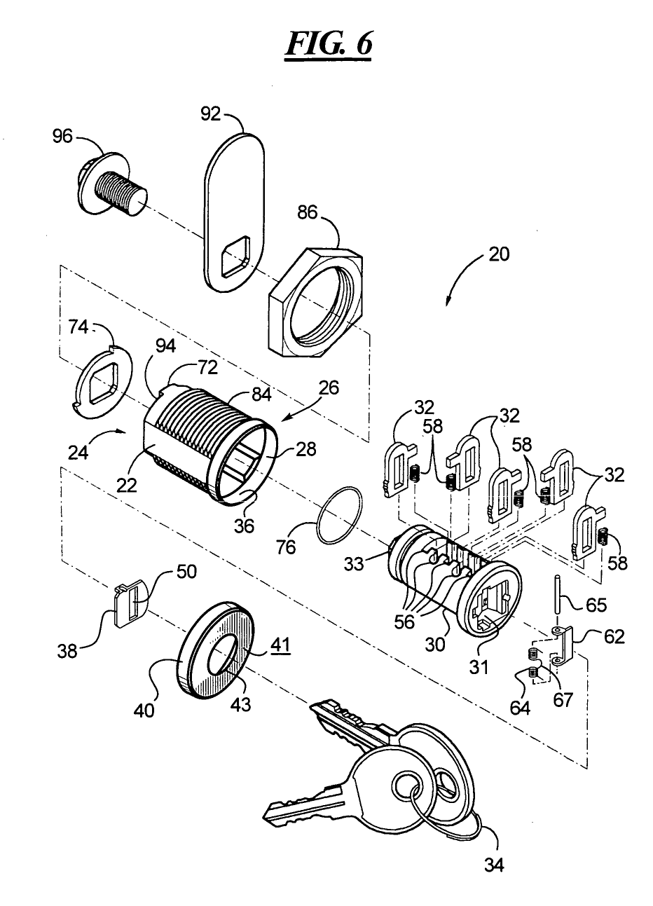

Referring to FIGS. 1-6, a key-actuated cam lock 20 constructed in accordance with the teachings of the present disclosure is shown. The cam lock 20 includes a lock housing 22 having a first end 24 and a second end 26. The lock housing 22 includes a bore 28 (shown in FIG. 5) that extends from the first end 24 to the second end 26 to house a plug body 30 (shown in FIG. 6). The plug body 30 includes a first end 31, a second end 33, and a plurality of spring-biased tumblers 32 that can be engaged with a key 34 to open and close the lock 20. The first end 24 of the lock housing 22 includes a circumferential inner rim 36 (shown in FIGS. 5 and 6) that is sized to house the first end 31 of the plug body 30. A closure plate 38 that includes a key opening 50 partially covers the first end 31 of the plug body 30. A generally cylindrical metal cap 40 is attached to the first end 24 of the lock housing 22 to securely cover the first end 24 of the lock housing 22, the first end 31 of the plug body 30 and portions of the closure plate 38. The first end 24 of the lock housing 22, the closure plate 38 and the metal cap 40 collectively define a lock face 42 (shown in FIGS. 1-3). When the lock 20 is attached to an object 44 (shown in FIG. 3), the lock face 42 is sized, shaped and arranged so as to be positioned substantially coplanar relative to an outer surface 46 of the object 44.

The lock 20 is corrosion-resistant and can be plated with duplex nickel chrome. The metal cap 40 can also be corrosion-resistant and includes a flat top surface 41 and a centrally disposed circular aperture 43. The circular aperture 43 exposes the key opening 50 of the closure plate 38 for insertion of the key 34 therein. The corrosion-resistant metal cap 40 is selected from the group consisting of a stainless steel cap, a brass cap, a copper alloy cap, and a galvanized metal cap. It is appreciated that other metals that are resistant to corrosion can be used.

Referring to FIG. 6, the closure plate 38 can also be corrosion-resistant. The closure plate 38 includes the key opening 50, which permits the entry of the key 34 through the closure plate 38 and into the plug body 30. The first end 31 of the plug body 30 is sized, shaped and arranged to receive the closure plate 38 such that the closure plate 38 is oriented substantially flush with the first end 31. The first end 31 of the plug body 30 may be referred to herein as the key entering end 52. Also, the second end 33 of the plug body 30 may be referred to herein as the cam actuating end 54. The plug body 30 is preferably constructed to receive a double-bitted reversible key 34. In this variant, the plug body 30 has apertures 56 disposed on the top and bottom (not shown) thereof as required to accommodate a plurality of springs 58 and the plurality of corresponding disc tumblers 32. The springs 58 bias the disc tumblers 32. The disc tumblers 32 engage the key 34 when the key 34 is inserted into the plug body 30 to either lock or unlock the lock 20.

The disc tumblers 32 and the springs 58 are protected from the elements by a trap door 62, which is biased in a closed position by a spring 64 until opened by the key 34. The trap door 62 is pivotally connected to the closure plate 38 by a pivot pin 65 and pivots about an axis (not shown) that is defined by the pivot pin 65. The pivot pin 65 traverses through the length of the spring 64 such that the pivot pin 65 also defines a longitudinal axis of the spring 64. The spring 64 includes a center tab 67 that presses on the back of the trap door 62 to bias the trap door 62 to a closed position, i.e., the key opening 50 being covered by the trap door 62. When the key 34 is inserted into the plug body 30, the key 34 pushes the trap door 62 to pivot the trap door 62 about the pivot pin 65. Accordingly, the trap door 62 moves the tab 67 to wind the spring 64. When the key 34 is removed, the spring 64 will force the trap door 62 back to close the key opening 50.

The Plug body 30 is disposed and rotatably positioned in the lock housing 22. The lock housing 22 has a generally cylindrical head 70, which has a rim 71. When the cam lock 20 is assembled, with the plug body 30 within the housing 22, the closure plate 38 seated over the key entering end 52 of the plug body 30, and the metal cap 40 attached over and around the rim 71 of the head 70, a weather-resistant, watertight seal is provided. The lock housing 22 has at least one limit stop 72 at the second end 26 of the lock housing 22. Preferably, there are at least two limit stops 72 disposed at the second end 26 to permit a stop plate 74 to rotate through a predetermined range of motion. Corrosion-resistant metal stop plate 74 is selected from the group consisting of a stainless steel stop plate, a brass stop plate, a copper alloy stop plate, and a galvanized metal stop plate.

The Plug body 30 has an internal O-ring 76 (shown in FIG. 6) providing a weather-resistant seal located near the cam actuating end 54 of the plug body 30. Preferably, the O-ring 76 is disposed between the cam actuating end 54 of the plug body 30 and the lock housing 22. The plug body 30 has an annular recess 87 disposed substantially near the cam actuating end 54. The annular recess 87 is dimensioned to sealably receive the O-ring 76 so that the O-ring 76 prevents water from penetrating the lock housing 22.

As shown in FIG. 5, the bore 28 of the lock housing 22 has a complementary annular recess 82 disposed thereon for sealably receiving the O-ring 76. It is appreciated that rotation of the plug body 30 in the lock housing 22 is permitted with sealing being provided by the O-ring 76. Entry of unwanted debris and the elements is eliminated through the use of the O-ring 76, and the combination of the other features of the key-actuated cam lock 20.

The corrosion-resistant metal stop plate 74 is a stainless steel stop plate in one embodiment of the invention. It is appreciated that the components of the key-actuated cam lock 20 are made of various types of corrosion-resistant metals. The corrosion-resistant metals are selected from the group consisting of stainless steel and brass, but other alloys are contemplated to be used therein. A particularly advantageous plating, which is found to produce unexpected results, includes a duplex nickel plating.

The lock housing 22 includes externally disposed threads 84 that engage a correspondingly threaded body nut 86 (shown in FIGS. 3 and 6). The threads 84 are sized, positioned, constructed and arranged for insertion into an aperture 88 (shown in FIG. 3) of the object 44 from the outer surface 46 of the object 44. The body nut 86 may be corrosion-resistant and include a nickel plating. As shown in FIG. 6, the body nut 86 may be a hex nut. The diameter of the lock face 42 is larger than the diameter of the aperture 88. Accordingly, by inserting the lock housing 22 as far as possible into the aperture 88, an inner side 90 (shown in FIG. 3) of the lock face 42 will abut the outer surface 46 of the object 44. To secure the lock housing 22 to the object 44, the body nut 86 can be screwed onto the externally disposed threads 84 and tightened so as to securely place the object 44 between the inner side 90 of the lock face 42 and the body nut 86. Accordingly, tightening the body nut 86 securely attaches the lock 20 to the object 44.

When the lock 20 is secured to the object 44 as described, the lock face 42 will be positioned substantially coplanar with the outer surface 46 of the object 44. The first end 24 of the lock housing 22, the first end 31 of the plug body 30, the closure plate 38, and the metal cap 40, collectively define the lock face 42. The disclosed substantially coplanar position of the lock face 42 relative to the outer surface 46 of the object 44 is due to the first end 24 of the lock housing 22, the first end 31 of the plug body 30, the closure plate 38, and the metal cap 40 being shallow or with relatively small thickness. Accordingly, the lock face 42 does not greatly project outward from the outer surface 46 of the object 44. Therefore, when viewed from the outer surface 46 of the object 44, the lock face 42 may be perceived as having a low profile, or may be perceived as being flush with the outer surface 46 of the object 44.

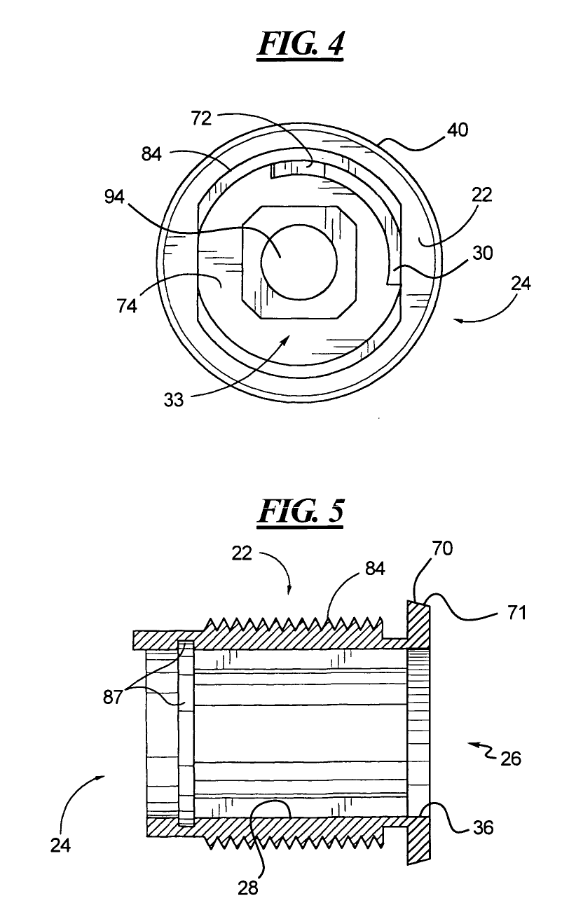

The cam actuating end 54 (shown in FIG. 4) is a square shape or other appropriate geometric shape for actuating and mating with the stop plate 74 and a cam 92. The cam actuating end 54 has a sem screw matable portion 94 (shown in FIG. 4), which has threads (not shown) that are complementary to a sem screw 96. In a preferred embodiment of the invention, the sem screw 96 is nickel-plated. The sem screw 96 secures the stainless steel stop plate 74 and the cam 92 to the plug body 30. Optionally, the cam 92 is a duplex nickel-plated cam.

In another preferred embodiment, the cam lock 20 comprises a stainless steel stop plate 74, brass interior components, a nickel-plated hex body nut 86, a nickel-plated sem screw 96 and, a duplex nickel-plated cam 92.

The O-ring 76 is made from a flexibly resilient polymeric material. It is optionally made from a material that is self-lubricating. The O-ring 76 can be made of a natural or synthetic rubber as required. Most preferably, the O-ring 76 is made of a salt-resistant polymeric material.

The present disclosure also provides a method of manufacturing a weather-resistant exterior cam lock 20. The method includes plating at least two components of the cam lock 20 with a corrosion-resistant metal. The components include the metal cap 40, the weather-resistant closure plate 38, the openable trap door 62, which is biased closed by the spring 64, the plug body 30, the springs 64 and 58, the disc tumblers 32, the lock housing 22, the metal stop plate 74, and the rotatable cam 92. The method includes providing a weather-resistant seal, which optionally includes the O-ring 76, located near the cam-actuating end 54 of the plug body 30; and, assembling a few or all of the above-noted components, in combination, to obtain the weather-resistant exterior cam lock 20.

The Applicant has discovered that the method described herein and the combination of preferred components of the key-actuated cam lock 20 result in a key-actuated cam lock that has superior performance capabilities over conventional key-actuated cam locks. These superior performance capabilities include the ability to maintain proper function after over about 480 hours of salt spray testing. Conventional cam locks generally malfunction after about 240 hours of salt spray testing. The present invention has an operable internal and external mechanism for actuating the cam lock 20 long after conventional cam locks freeze up in similar test conditions.

These unexpected results are seen in situations where the plating of components of the cam lock 20 includes duplex nickel chrome plating. Preferably, the cam lock includes a stainless steel stop plate 74; brass plug body 30; nickel-plated hex nut 86; nickel-plated sem screw 96; duplex nickel-plated cam 92; and, a weather-resistant seal that comprises an O-ring 76.

While only a few preferred embodiments of the invention have been described hereinabove, those of ordinary skill in the art will recognize that the embodiment may be modified and altered without departing from the central spirit and scope of the invention. Thus, the preferred embodiment described hereinabove is to be considered in all respects as illustrative and not restrictive, the scope of the invention being indicated by the appended claims, rather than by the foregoing description, and all changes that come within the meaning and range of equivalency of the claims are intended to be embraced herein.

1. A key-actuated cam lock for attachment to an object, the cam lock comprising:
a plug body having a first end and a second end, said plug body further including a plurality of spring-biased tumblers engaging the key when the key is inserted into said plug body;
a closure plate configured to partially cover the first end of said plug body, said closure plate having a substantially flat outer face, the outer face having a key opening to permit entry of the key;
a lock housing having a first end and a second end, said lock housing having a bore extending from the first end to the second end and configured to rotatably house said plug body, the first end having a circumferential inner rim sized and arranged for mating engagement with the first end of the plug body;
wherein a portion of the first end of said lock housing having engaged therein at least a portion of said first end of the plug body, and at least a portion of the closure plate define a lock face; and
wherein said lock face is configured to be substantially coplanar relative to an outer surface of the object when said lock housing is attached to the object.

2. The cam lock of claim 1, wherein the closure plate is weather-resistant.

3. The cam lock of claim 1, wherein the lock housing is corrosion-resistant.

4. The cam lock of claim 1, further comprising an O-ring disposed between said plug body and said lock housing substantially near the second end of said plug body, the O-ring constructed and arranged to provide a weather-resistant seal between the plug body and the lock housing.

5. The cam lock of claim 4, wherein said plug body has an annular recess disposed substantially near said second end of said plug body, said annular recess dimensioned to sealably receive said O-ring, whereby said O-ring prevents water from penetrating said lock.

6. The cam lock of claim 1, further comprising a trap door operatively coupled to the closure plate, said trap door being moveable between a closed position covering the key opening of said closure plate and an open position, wherein said trap door is spring-biased to the closed position.

7. The cam lock of claim 1, further comprising a generally annular corrosion-resistant metal cap having a centrally disposed aperture and a substantially flat top surface, wherein the metal cap is configured for mating engagement over a circumferential outer rim of said lock housing.

8. The cam lock of claim 7, wherein said corrosion-resistant metal cap is selected from the group consisting of a stainless steel cap, a brass cap, a copper alloy cap, and a galvanized metal cap.

9. The cam lock of claim 1, wherein said cam lock is plated with duplex nickel chrome.

10. The cam lock of claim 1, said plug housing having at least one rotation limit stop disposed therein, said second end of the said plug body being connected to a corrosion-resistant metal stop plate engaging said limit stop upon rotation of said plug body.

11. The cam lock of claim 10, wherein said corrosion-resistant metal stop plate is selected from the group consisting of a stainless steel stop plate, a brass stop plate, a copper alloy stop plate, and a galvanized metal stop plate.

12. The cam lock of claim 10, wherein said corrosion-resistant metal stop plate is a stainless steel stop plate, and further comprising threads located on an exterior portion of said lock housing; said threads being sized, positioned, constructed and arranged for threaded insertion into an aperture in the object to be locked; a nickel-plated body nut capable of engaging said threads and securably mounting said lock housing; the second end of said lock housing having a sem screw matable portion; a nickel-plated sem screw securing said stainless steel stop plate and said cam to said plug body; and, wherein said cam is a duplex nickel-plated cam.

13. The cam lock of claim 12, wherein said nut is a hex nut.

14. A key-actuated cam lock comprising:
a plug body having a first end and a second end, said plug body further including a plurality of spring-biased tumblers engaging the key when the key is inserted into said plug body, the first end of said plug body extending outwardly from an outer surface of an object when said plug body is attached to the object to partially define a lock face, wherein the lock face is substantially coplanar with the outer surface of the object when said plug body is attached to the object;
a weather-resistant closure plate configured to partially cover the first end of said plug body, said closure plate having a substantially flat outer face, the outer face having a key opening to permit entry of the key;
a corrosion-resistant lock housing having a first end and a second end, said lock housing having a bore extending from the first end to the second end and configured to rotatably house said plug body, the first end having a circumferential inner rim configured and arranged for mating engagement with the first end of the plug body;
an O-ring disposed between said plug body and said lock housing substantially near the second end of the lock housing, said O-ring configured to provide a weather-resistant seal between said plug body and said lock housing; and
a generally annular corrosion-resistant metal cap having a centrally disposed aperture and a substantially flat top surface, wherein the metal cap is configured for mating engagement over a circumferential outer rim of said lock housing.

15. The cam lock of claim 14, further comprising a trap door operatively coupled to the closure plate, said trap door being moveable between a closed position covering the key opening of said closure plate and an open position, wherein said trap door is spring-biased to the closed position.

16. The cam lock of claim 14, wherein said corrosion-resistant metal cap is selected from the group consisting of a stainless steel cap, a brass cap, a copper alloy cap and a galvanized metal cap.

17. A method of creating a weather-resistant exterior cam lock, comprising:
plating at least two components of said cam lock with a corrosion-resistant metal, said components selected from the group consisting of a cylindrical metal cap, having a centrally disposed aperture and a substantially flat top surface, a weather-resistant closure plate having an openable trap door permitting the entry of a key, a plug body, said plug body having a first end and a second end, spring-biased disc tumblers, a lock housing, said lock housing having a substantially cylindrical head circumferentially disposed about a first end of said lock housing, said cylindrical head configured for mating engagement with said corrosion-resistant metal cap; said mating of said cylindrical head and said metal cap partially providing a lock face being substantially coplanar relative to an outer surface of an object when said cam lock is attached to said object; a metal stop plate, and a rotatable cam;
providing a weather-resistant seal substantially near the second end of said plug body, said weather-resistant seal disposed between the second end of said plug body and said lock housing; and
assembling said components of said weather-resistant exterior cam lock.

18. The method of claim 17, wherein said step of plating components of said cam lock with a corrosion-resistant metal includes duplex nickel chrome plating.

19. The method of claim 17, further comprising a stainless steel stop plate; a brass plug body; a nickel-plated hex nut; a nickel-plated sem screw; and, a duplex nickel-plated cam.

20. The method of claim 17, wherein said weather-resistant seal comprises an O-ring.
